(19) United States
(12) Patent Application Publication
(10) Pub. No.: US 2015/0096889 A1
(43) Pub. Date: Apr. 9, 2015

(54) CORROSION MONITORING DEVICE OF REINFORCED CONCRETE CONSTRUCTION

(71) Applicant: Research & Business Foundation SUNGKYUNKWAN UNIVERSITY, Suwon-si (KR)

(72) Inventors: Seunghee PARK, Seongnam-si (KR); Jisung LEE, Gwacheon-si (KR); Hyuckjin KWON, Suwon-si (KR); Junkyeong KIM, Suwon-si (KR)

(73) Assignee: Research & Business Foundation SUNGKYUNKWAN UNIVERSITY, Suwon-si (KR)

(21) Appl. No.: 14/507,232

(22) Filed: Oct. 6, 2014

(30) Foreign Application Priority Data
Oct. 8, 2013 (KR) 10-2013-0120013

(51) Int. Cl. G01N 17/02; G01N 17/00

(52) U.S. Cl. CPC G01N 17/02; G01N 17/006
USPC 204/404

(57) ABSTRACT

Provided herein is a device for monitoring corrosion of steel for a steel concrete construction, the device including a battery provided with a first electrode, a second electrode made of a metal material having a higher electric potential than concrete steel reinforcement and spaced from the first electrode, and an electrolyte contacting the second electrode and first electrode and providing a path for ions to pass, the battery disposed inside the steel concrete construction and configured to collect electric energy generated through oxidation/reduction, that is a corrosion process of steel reinforcement; a capacitor electrically connected to the battery and configured to store electric energy; and an electric charge measurer configured to measure an amount of electric energy storage of the capacitor.

### CROSS-REFERENCE TO RELATED APPLICATION

This application claims the benefit of priority under 35 U.S.C. §119(a) of Korean Patent Application No. 10-2013-0120013, filed on Oct. 8, 2013, in the Korean Intellectual Property Office, the entire disclosure of which is incorporated herein by reference for all purposes.

### 1. FIELD

Various embodiments of the present invention relate to a corrosion monitoring device of reinforced concrete construction, and more particularly to a corrosion monitoring device of reinforced concrete construction capable of collecting electric energy that is generated as steel reinforcement corrodes, and using it as a power source of the corrosion monitoring device.

### 2. BACKGROUND

Steel reinforced concrete that is most widely used in construction and civil engineering is a construction material with excellent economic feasibility and durability.

So far, it has been common sense that steel reinforced concrete has a life span of about half a century. Thus, steel reinforced concrete structures have been used for that period without any special maintenance control.

In fact, steel reinforced concrete made of concrete and steel reinforcement combined is known as a composite material having optimal functions not only in terms of mechanical strength but also in terms of long term durability.

However, according to numerous research results and field studies recently conducted, it has been found that corrosion of steel reinforcement is deteriorating the durability of steel reinforced concrete, causing serious problems in constructions overall.

The biggest reason that deteriorates the durability of a steel reinforced construction is corrosion of reclaimed steel reinforcement. And the main causes of corrosion of steel reinforcement are chlorine ion and carbon dioxide that penetrate from inside or outside.

Once steel reinforcement corrodes, corrosion product is formed on a surface of the steel reinforcement, making the surface crack and peel off. Such cracks and peeling off make it easy for harmful factors from outside to penetrate inside, thereby accelerating the corrosion of steel reinforcement.

Consequently, the safety and durability of steel reinforced construction may deteriorate significantly, and in some cases, make the steel reinforcement constructions collapse. Furthermore, repairing and reinforcing the steel reinforced concrete constructions that are already damaged may be very difficult, restrictive, and costly.

Therefore, non-destructive methods based on an ATM (Active Monitoring Technique) and PMT (Passive Monitoring Technique) are being performed in order to quantitatively measure the corrosion of steel reinforcement in steel reinforced concrete constructions, evaluate the condition of the steel reinforced constructions, and predict an appropriate time point to repair the constructions. However, field applicability and reliability are extremely low.

Especially, the amount of electric energy that is generated during the process of corrosion of the steel reinforcement inside the steel reinforced concrete is not much, but it is still not a small amount considering the size of steel reinforced concrete constructions and the length of time the corrosion takes place. Nevertheless, the electric energy is being wasted without being used.

### SUMMARY

A purpose of various embodiments of the present invention is to resolve the aforementioned problems of prior art, that is to provide a corrosion monitoring device of reinforced concrete construction capable of collecting electric charges that are generated as the steel reinforcement corrodes, and using the collected electric charges as electric energy, thereby realizing energy harvesting.

Another purpose of various embodiments of the present invention is to provide a corrosion monitoring device of reinforced concrete construction capable of improving an efficiency of collecting electric energy by arranging first comb-pattern electrodes and second comb-pattern electrodes alternately on a first electrode and second electrode, respectively, so as to expand a reaction surface of a battery.

Another purpose of various embodiments of the present invention is to provide a corrosion monitoring device of reinforced concrete construction capable of generating a large potential difference using a graphene as cathode while maximizing an efficiency of an electrode of a battery at the same time.

Another purpose of various embodiments of the present invention is to provide a corrosion monitoring device of reinforced concrete construction capable of providing power source of a booster and electric charge measurer using collected electric energy, and thus that doesn't need an external power source.

Another purpose of various embodiments of the present invention is to provide corrosion monitoring device of reinforced concrete construction capable of providing power source for electronic devices required in monitoring corrosion using electric energy that is generated as steel reinforcement corrodes, and thus that doesn't need additional external power source.

According to an embodiment of the present invention, there is provided a corrosion monitoring device of reinforced concrete construction, the device including a battery provided with a first electrode, a second electrode made of a metal material having a higher electric potential than concrete steel reinforcement and spaced from the first electrode, and an electrolyte contacting the second electrode and first electrode and providing a path for ions to pass, the battery disposed inside the steel concrete construction and configured to collect electric energy generated through oxidation/reduction, that is a corrosion process of steel reinforcement; a capacitor electrically connected to the battery and configured to store electric energy; and an electric charge measurer configured to measure an amount of electric energy storage of the capacitor.

On a surface of the first electrode facing the second electrode, a plurality of first comb pattern electrodes may be arranged parallel to one another extending towards the second electrode, and on a surface of the second electrode facing the first electrode, a plurality of second comb pattern electrodes may be arranged alternately with the first comb pattern electrodes and extends towards the first electrode.

The first electrode may be made of a carbon material.

The carbon material may be a graphene material.

The second electrode may be disposed on both sides of the first electrode and are electrically connected to each other.

The electrolyte may be made of mortar containing a carbon fiber compound and having electroconductivity.

The second electrode may be made of a magnesium material.

The device may further include a booster electrically connected to the battery and configured to receive the electric energy collected in the battery and raise a voltage.

The booster and electric charge measurer may be driven by the electric energy stored in the capacitor.

A wiring terminal may be configured to connect the battery and the booster is made of aluminum or carbon material.

According to the aforementioned various embodiments of the present invention, there is provided a corrosion monitoring device of reinforced concrete construction capable of collecting electric charges that are generated as the steel reinforcement corrodes, and using the collected electric charges as electric energy, thereby realizing energy harvesting.

Furthermore, there is provided a corrosion monitoring device of reinforced concrete construction capable of improving an efficiency of collecting electric energy by arranging first comb-pattern electrodes and second comb-pattern electrodes alternately on a first electrode and second electrode, respectively, in order to expand a reaction surface of a battery.

Furthermore, there is provided a corrosion monitoring device of reinforced concrete construction capable of generating a large potential difference using a graphene as cathode while maximizing an efficiency of an electrode of a battery at the same time.

Furthermore, there is provided a corrosion monitoring device of reinforced concrete construction capable of providing power source of a booster and electric charge measurer using collected electric energy, and thus that doesn't need an external power source.

Furthermore, there is provided a corrosion monitoring device of reinforced concrete construction capable of providing power source for electronic devices required in monitoring corrosion using electric energy that is generated as steel reinforcement corrodes, and thus that doesn't need additional external power source.

### BRIEF DESCRIPTION OF THE DRAWINGS

Throughout the drawings and the detailed description, unless otherwise described, the same drawing reference numerals will be understood to refer to the same elements, features, and constructions. The relative size and depiction of these elements may be exaggerated for clarity, illustrating, and convenience.

FIG. 1 is a schematic configuration view of a corrosion monitoring device of reinforced concrete construction according to an embodiment of the present invention;

FIG. 2 is an perspective excerpt view of a battery of a corrosion monitoring device of reinforced concrete construction according to an embodiment of the present invention; and

FIG. 3 is a flowchart of an operating order of a corrosion monitoring device of reinforced concrete construction according to an embodiment of the present invention.

### DETAILED DESCRIPTION

Hereinafter, a corrosion monitoring device of reinforced concrete construction according to an embodiment of the present invention will be explained in detail with reference to the drawings attached.

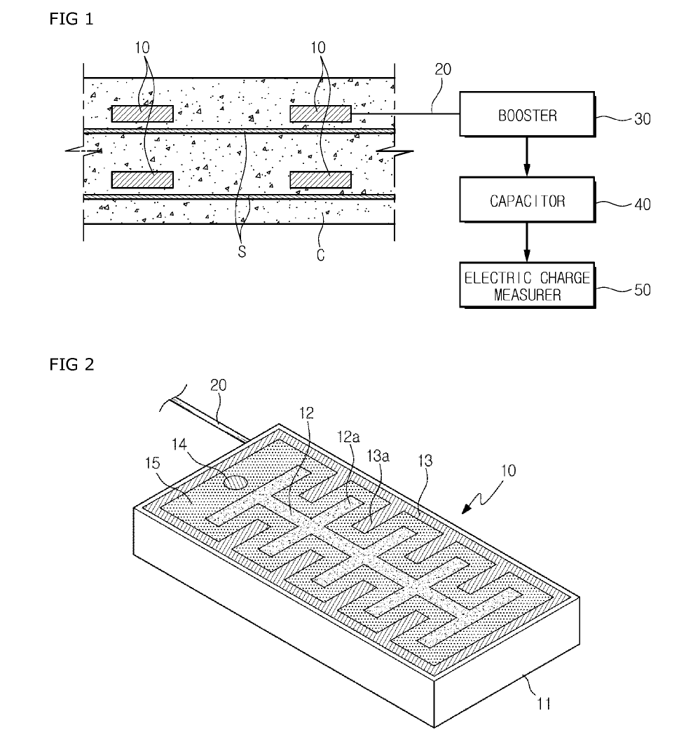

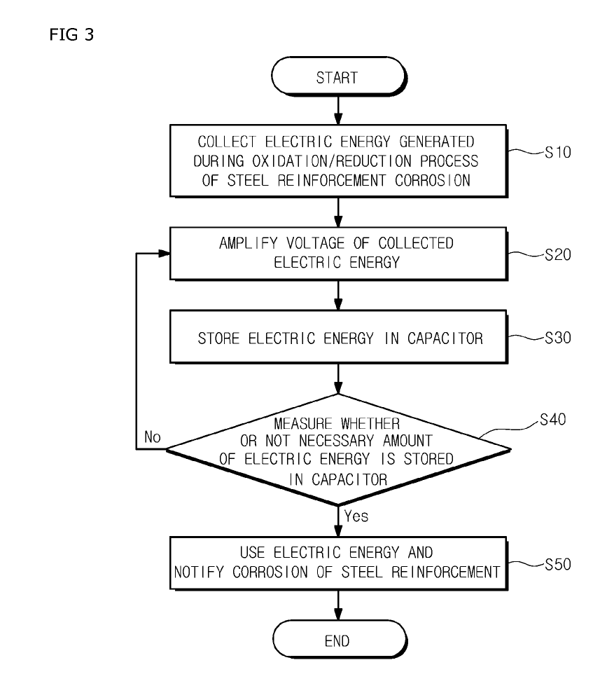

FIG. 1 is a schematic configuration view of a corrosion monitoring device of reinforced concrete construction according to an embodiment of the present invention, and FIG. 2 is a perspective excerpt view of a battery of a corrosion monitoring device of reinforced concrete construction according to an embodiment of the present invention.

A corrosion monitoring device of reinforced concrete construction according to an embodiment of the present invention as illustrated in FIGS. 1 and 2 include a battery 10, wiring terminal 20, booster 30, capacitor 40, and electric charge measurer 50.

The battery 10 is disposed near a steel reinforcement (R) inside a steel concrete construction (C), and collects electric energy that is generated through oxidation/reduction which are corrosion processes of steel reinforcement (R). The battery 10 includes a housing 11 wherein an accommodating space having an aperture is formed inside, a first electrode 12 disposed in a center of the aperture of the housing 11 in a longitudinal direction 12, a second electrode 13 spaced from the first electrode, a plurality of comb-pattern electrodes 12a arranged parallel to one another extending towards the second electrode on a surface of the second electrode facing the first electrode, a plurality of second comb pattern electrodes 13a arranged alternately with the first comb pattern electrodes and extending towards the first electrode 12, and an electrolyte 15 filled in the accommodating space of the housing 11, contacts the second electrode 13 and the first electrode 12, and provides a path through which ions move.

The first electrode 12 may be made of a carbon material, and desirably, a graphene material.

Furthermore, the second electrode 13 may be made of a metal material having a higher electric potential than the steel reinforcement (R) for a concrete construction (C), and desirably, a magnesium material.

The second electrode 13 may be disposed on both sides of the first electrode and be electrically connected to each other. More specifically, as illustrated in FIG. 2, the second electrode 13 may be disposed along a rim of the aperture of the housing 11.

Furthermore, desirably, the electrolyte 15 may be made of mortar containing a carbon fiber compound and thus having electroconductivity.

The battery 10 may be configured such that a reference electrode 14 is disposed in a space between the first electrode 12 and second electrode 13 in the aperture of the housing 11 and the battery 10 measure corrosion of the steel reinforcement (R) using a relative electric potential difference of an electric potential measurement between the second electrode 13 and reference electrode 14 regarding a reference electric potential between the second electrode 13 and reference electrode 14.

One end of the wiring terminal 20 is connected to the battery 10 such that the battery 10 disposed inside the concrete construction (C) and the booster 30 disposed outside the concrete construction (C) are electrically connected, and another end is exposed outside the concrete construction (C). The wiring terminal 20 is made of an aluminum or carbon material.

The booster 30 is connected to the wiring terminal 20 exposed outside the concrete construction (C) while being electrically connected to the battery 10 so as to receive the electric energy collected in the battery 10 and increase a voltage. The booster 30 is driven by the electric energy stored in the capacitor 40.

The capacitor 40 is electrically connected to the booster 30 and stores the electric energy of which the voltage has been increased by the booster 30. The capacitor 40 may be desirably set to have an appropriate amount of storage depending on its purpose of using energy.

The electric charge measurer 50 measures the amount of electric energy storage of the capacitor 40, and is driven by the electric energy stored in the capacitor 40. More specifically, the capacitance of the capacitor 40 is divided into numerous stages such that the amount of electric energy storage in the capacitor 40 does not exceed the capacitance of the capacitor 40, and as the amount of electric energy storage increases/decreases to reach each stage, the amount of electric energy storage of the capacitor 40 is notified to a central center. For this purpose, the electric charge measurer 50 may be provided with a wired or wireless transmitter configured to transmit the amount of electric energy storage.

Hereinafter, an operation of a corrosion monitoring device of reinforced concrete construction according to an embodiment of the present invention will be explained.

As illustrated in FIGS. 1 and 2, when the battery 10 is disposed near the steel reinforcement (R) disposed inside the steel reinforced concrete construction (C), as a large electric potential difference is generated between the first electrode 12 and second electrode 13 of the battery 10 by an electric charge generated during corrosion of the steel reinforcement (R), an electric charge is collected inside the battery 10 (S10).

More specifically, an oxidation reaction defined as an anode reaction is a sacrificial anode electric method that uses the corrosion principle between dissimilar metals. In the case where a steel reinforcement is made into a cathode by electrically connecting a second electrode 13 made of a metal material (for example magnesium material) having a higher electric potential than the steel reinforcement (subject metal of anticorrosion), magnesium which is relatively nonmetal corrodes, while the steel reinforcement which is a precious metal is anodized and anticorroded.

Mg→Mg²⁺+2e⁻

Mg²⁺2(OH)⁻→Mg(OH)₂

4Mg(OH)₂+O₂+2H₂O→4Mg(OH)₃ <Chemical formula 1>

That is, as in the above chemical formula 1, ions of magnesium, which is relatively a nonmetal, will enter the electrolyte, while electrons of the magnesium are amplified as they go through the booster 30, and then stored in the capacitor 40.

According to such a structure of the battery 10, by applying a graphene material having an excellent electroconductivity to the first electrode, the electrode efficiency of the battery 10 may be maximized. Furthermore, the first comb pattern electrodes 12a and second comb pattern electrodes 13a formed in comb patterns to the first electrode 12 and second electrode 13, respectively, are alternately arranged on a front surface of the aperture of the housing 11, thereby forming a large reaction surface and improving the efficiency of collecting electric energy.

As such, the electric energy collected in the battery 10 is transmitted to the booster 30 to the wiring terminal 20, thereby amplifying the voltage (S20). Then, the amplified electric energy is stored in the capacitor 40 (S30).

$$E = \frac{1}{2} {CV}^{2} \qquad 〈 Math formula 1 〉$$

(wherein E is energy, C is capacitance, and V is voltage)

The electric charge measurer 50 connected to the capacitor 40 measures the amount of electric energy storage in the capacitor 40 using the above math formula 1, determines whether or not a necessary amount of energy is stored (S40), and uses the electric energy. And then, the electric charge measurer 50 notifies that steel reinforcement corrosion is underway (S50).

Herein, the capacitance of the capacitor 40 is divided into numerous stages, and whenever the amount of electric energy storage reaches any one stage of the numerous stages, the central center is notified of the capacity, thereby informing that a corrosion of steel reinforcement has occurred near the battery 10.

Furthermore, by supplying the electric energy stored in the capacitor to the booster 30 and the electric charge measurer 50 electrically connected to the capacitor 40 to be used as power source, the amount of electric energy stored is prevented from exceeding the capacitance of the capacitor 40.

That is, by using the battery 10 where graphene and magnesium are used as electrodes to collect the electric energy generated by the electric potential difference generated during corrosion of steel reinforcement, and then by using the collected electric energy as power source of the booster 30 and electric charge measurer 50, energy harvesting can be realized. Furthermore, since self generation becomes possible, there is no need to connect an additional external power source to the booster 30 and electric charge measurer 50.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims. Therefore, the aforementioned embodiments should be understood to be exemplary but not limiting the present invention in any way.

What is claimed is:

1. A corrosion monitoring device of reinforced concrete construction, the device comprising:
a battery provided with a first electrode, a second electrode made of a metal material having a higher electric potential than concrete steel reinforcement and spaced from the first electrode, and an electrolyte contacting the second electrode and first electrode and providing a path for ions to pass, the battery disposed inside the steel concrete construction and configured to collect electric energy generated through oxidation/reduction, that is a corrosion process of steel reinforcement;
a capacitor electrically connected to the battery and configured to store electric energy; and
an electric charge measurer configured to measure an amount of electric energy storage of the capacitor.

2. The device according to claim 1,
wherein on a surface of the first electrode facing the second electrode, a plurality of first comb pattern electrodes are arranged parallel to one another extending towards the second electrode, and
on a surface of the second electrode facing the first electrode, a plurality of second comb pattern electrodes are arranged alternately with the first comb pattern electrodes and extends towards the first electrode.

3. The device according to claim 1,
wherein the first electrode is made of a carbon material.

4. The device according to claim 3,
wherein the carbon material is a graphene material.

5. The device according to claim 2,
wherein the second electrode is disposed on both sides of the first electrode and are electrically connected to each other.

6. The device according to claim 2,
wherein the electrolyte is made of mortar containing a carbon fiber compound having electroconductivity.

7. The device according to claim 1,
wherein the second electrode is made of a magnesium material.

8. The device according to claim 1,
further comprising a booster electrically connected to the battery and configured to receive the electric energy collected in the battery and raise a voltage.

9. The device according to claim 8,
wherein the booster and electric charge measurer are driven by the electric energy stored in the capacitor.

10. The device according to claim 8,
wherein a wiring terminal configured to connect the battery and the booster is made of an aluminum or carbon material.
